(19) United States
(12) Patent Application Publication
(10) Pub. No.: US 2025/0381860 A1
(43) Pub. Date: Dec. 18, 2025

(54) ADAPTER FOR ELECTRIC VEHICLE CHARGING CONNECTORS

(71) Applicant: EVject, Inc., American Fork, UT (US)

(72) Inventors: Erick Vega, Salt Lake City, UT (US); Kreg Peeler, Draper, UT (US)

(21) Appl. No.: 18/741,527

(22) Filed: Jun. 12, 2024

(51) Int. Cl. B60L 53/16; B60L 53/66; H01R 13/627; H01R 13/66; H01R 13/70

(52) U.S. Cl. CPC B60L 53/16; B60L 53/66; H01R 13/6272; H01R 13/6691; H01R 13/701; H01R 2201/26

(57) ABSTRACT

An adapter can be configured to allow an EV to be shifted from park even though the charging connector is still connected to the charging port. As a result, a driver need not leave the EV to unplug the charging connector. An adapter may include a switching element that may form an electrical connection to notify the EV that the charging connector is plugged into the charging port. The adapter may also include a receiver that is configured to open the switching element in response to a transmitted signal to thereby terminate the electrical connection which in turn will cause the EV to believe the charging connector has been unplugged. An adapter may also or alternatively include a delay mechanism that is configured to cause the switching element to reconnect the electrical connection after it has been terminated but when the adapter and charging connector remain plugged into the charging port.

### CROSS-REFERENCE TO RELATED APPLICATIONS

N/A

### BACKGROUND

Electric vehicles (or EVs), whether cars, trucks or otherwise, must be frequently recharged. For this purpose, EVs have charging ports that are typically located on the outside. FIGS. 1A and 1B provide an example of a Tesla 100 that has a charging port 110 into which a charging connector 120 can be plugged. Charging connector 120 can be electrically connected to a power source such as a 240-volt outlet at home or a public charging station. Other makes of EVs have similar charging ports that require similar charging connectors.

It can take a relatively long time to fully charge an EV. For example, with a typical 240-volt at-home charger, a full charge may take 8 hours. Even with high-voltage superchargers, it usually takes at least 30-40 minutes to reach a full charge.

Global EV charging standards prevent any motion of the EV while the EV is connected to a charger. Therefore, the vehicle must remain parked while connected to the charger and cannot be shifted to drive, reverse, or neutral. Additionally, current charger designs require manual removal of the charging connector from the charging port. This can create various difficulties.

Greater difficulties may arise in scenarios where the driver is waiting in the EV while it charges. For example, a thunderstorm or other severe weather could occur when charging is complete thus forcing the driver to brave the elements to unplug the EV. As another example, a charging station may be in a remote or dangerous location where it may be unsafe for the driver to exit the EV such as due to the presence of wildlife or a lurking assailant. In such cases, the driver will in essence be trapped inside the EV given that he or she cannot drive away until the EV is unplugged.

### BRIEF SUMMARY

Embodiments of the present disclosure are directed to adapters for EV charging connectors. The adapter allows an EV to be shifted from park even though the charging connector is still connected to the charging port. As a result, a driver need not leave the EV to unplug the charging connector.

An adapter may include a switching element that may form an electrical connection to notify the EV that the charging connector is plugged into the charging port. The adapter may also include a receiver that is configured to open the switching element in response to a transmitted signal to thereby terminate the electrical connection which in turn will cause the EV to believe the charging connector has been unplugged.

An adapter may also or alternatively include a delay mechanism that is configured to cause the switching element to reconnect the electrical connection after it has been terminated but when the adapter and charging connector remain plugged into the EV's charging port. The delay mechanism can provide a way to detect that an EV has remained at the charging station after charging has been terminated.

In some embodiments, an adapter for an electric vehicle may include an inner portion configured to insert into a charging port of an electric vehicle, an outer portion configured to receive a charging connector for charging the electric vehicle, circuitry that is configured to establish an electrical connection through one or more communication pin assemblies, and a receiver that is configured to terminate the electrical connection in response to receiving a wireless signal.

In some embodiments, the circuitry may include a switching element.

In some embodiments, the inner portion and the outer portion may be configured in accordance with the combined charging system (CCS) standard.

In some embodiments, one of the inner portion and the outer portion may be configured in accordance with the combined charging system (CCS) standard and the other of the inner portion and the outer portion may be configured in accordance with the North American Charging Standard (NACS).

In some embodiments, the inner portion and the outer portion may be configured in accordance with the NACS.

In some embodiments, the circuitry may include a switching element.

In some embodiments, the circuitry may be configured to reestablish the electrical connection after a delay.

In some embodiments, the circuitry may be configured to reestablish the electrical connection after the delay in response to movement of one or more mechanical members.

In some embodiments, the one or more mechanical members may include a plunger.

In some embodiments, the adapter may include a battery for powering the receiver.

In some embodiments, the battery may be selectively connected to the receiver when the adapter is inserted into a charging port.

In some embodiments, the adapter may include a locking mechanism that selectively connects the receiver to the battery when the adapter is inserted into a charging port.

In some embodiments, an adapter for an electric vehicle may include an inner portion configured to insert into a charging port of an electric vehicle, an outer portion configured to receive a charging connector for charging the electric vehicle, and circuitry that is configured to establish an electrical connection through one or more communication pin assemblies. The circuitry may be further configured to terminate the electrical connection and then to automatically reestablish the electrical connection after a delay.

In some embodiments, the circuitry may automatically reestablish the electrical connection after the delay when the adapter remains inserted into the charging port of the electric vehicle.

In some embodiments, the adapter may include one or more members that move to cause the circuitry to automatically reestablish the electrical connection after the delay.

In some embodiments, the one or more members may also move to cause the circuitry to terminate the electrical connection.

In some embodiments, an adapter for an electric vehicle may include an inner portion configured to insert into a charging port of an electric vehicle, an outer portion configured to receive a charging connector for charging the electric vehicle, and a locking mechanism that is configured to lock the charging connector in the outer portion while the inner portion is inserted into the charging port.

In some embodiments, the locking mechanism may include a main body that moves horizontally when the inner portion is inserted into the charging port and a tab member that moves vertically when the main body moves horizontally.

In some embodiments, the adapter may also include a receiver and a battery. The locking mechanism may be configured to selectively connect the battery to the receiver while the inner portion is inserted into the charging port.

In some embodiments, the locking mechanism may include an inner portion that is moved by a locking mechanism of the charging port and an outer portion that interfaces with the charging connector in response to the movement of the inner portion.

### BRIEF DESCRIPTION OF THE DRAWINGS

FIGS. 1A and 1B provide an example of an EV with a charging port.

FIGS. 2A-2C provide examples of adapters that are configured in accordance with one or more embodiments of the present disclosure.

FIGS. 3A-3C illustrate how the internal components of the adapter shown in FIG. 2A could be configured in one or more embodiments of the present disclosure.

FIG. 4 illustrates how the internal components of the adapter shown in FIG. 2B could be configured in one or more embodiments of the present disclosure.

FIGS. 5A and 5B provide an example of how a receiver can be used in an adapter to enable an electrical connection between a charging port and a charging connector to be terminated using a transmitted signal in accordance with one or more embodiments of the present disclosure.

FIGS. 6A-6D provide an example of how a switching element in an adapter can be configured to automatically return to a closed position after a period of time in accordance with one or more embodiments of the present disclosure.

FIG. 7 provides another example of how a switching element in an adapter can be configured to automatically return to a closed position after a period of time in accordance with one or more embodiments of the present disclosure.

FIGS. 8A-8C provide an example of a locking mechanism that may be employed in an adapter in accordance with one or more embodiments of the present disclosure.

FIGS. 9A and 9B provide an example of how a locking mechanism can be configured to selectively power a receiver in accordance with one or more embodiments of the present disclosure.

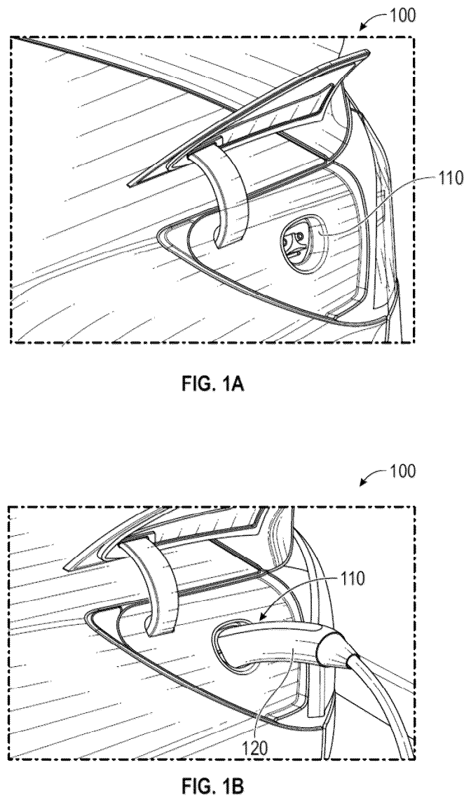

### DETAILED DESCRIPTION

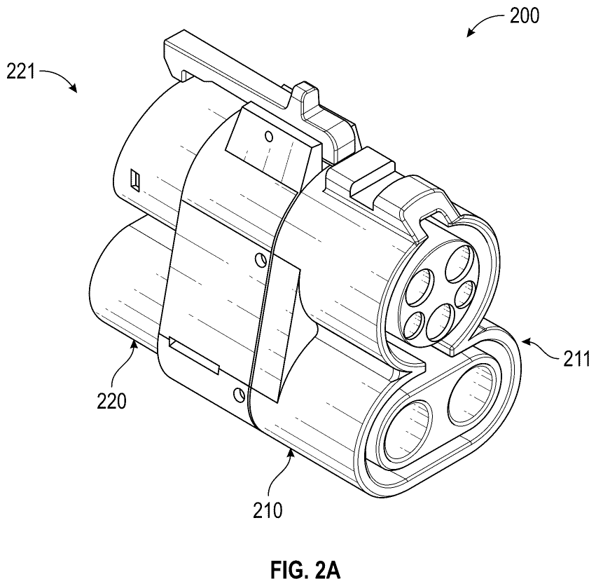

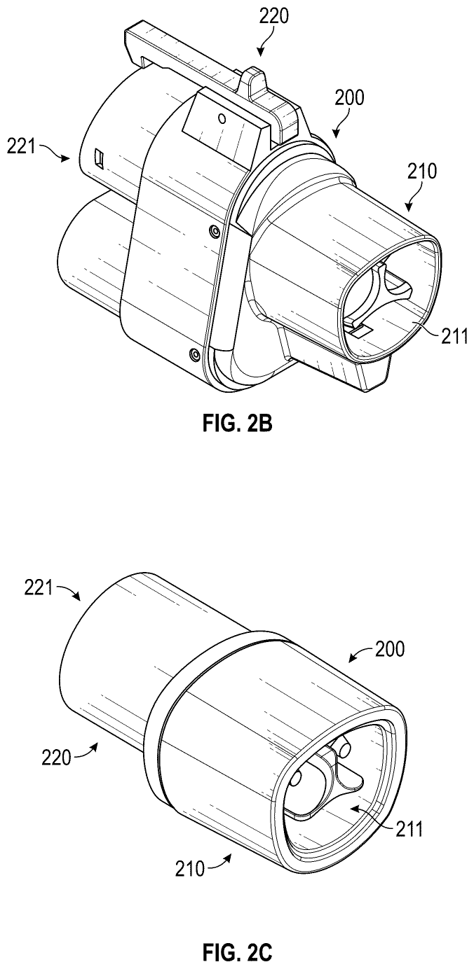

FIGS. 2A-2C each provide an example of an adapter 200 that is configured in accordance with one or more embodiments of the present disclosure. Adapter 200 includes an outer portion 210 having an end 211 that is configured to receive a charging connector for an EV (i.e., it can be shaped to match a charging port of the EV) and an inner portion 220 having an end 221 that is configured to be inserted into a charging port of the EV (i.e., it can be shaped to match the charging connector for the EV). In FIG. 2A, both ends 211 and 221 are configured in accordance with combined charging system (CCS) standard. In FIG. 2B, ends 211 and 221 are configured in accordance with the North American Charging Standard (NACS (or Tesla)) and CCS standard respectively. In FIG. 2C, both ends 211 and 221 are configured in accordance with NACS. Although not shown, adapter 200 could also have ends 211 and 221 that are configured in accordance with NACS and the CCS standard respectively. Additionally, ends 211 and 221 could be configured with any other standard currently in use in the world (e.g., J1772 type 1 and type 2) or any standard that may be developed in the future. Accordingly, embodiments of the present disclosure should not be limited to any particular standard for charging ports and/or charging connectors.

In some embodiments, adapter 200 can be configured to selectively form an electrical connection between the charging port and the charging connector. In such embodiments, any suitable mechanism and/or technique may be used to cause the electrical connection to be selectively formed. Various examples are described in U.S. Pat. No. 11,884,170 and U.S. patent application Ser. No. 18/598,641, which are incorporated herein by reference (the “Incorporated References”). In other embodiments, adapter 200 can be configured to form an electrical connection by default.

In accordance with embodiments of the present disclosure, adapter 200 can include a receiver that is configured to detect a transmitted signal. In response to detecting the signal, the receiver can terminate the electrical connection between the charging port and the charging connector. When the electrical connection is terminated, the EV will allow the driver to shift the EV from park without unplugging the adapter and charging connector.

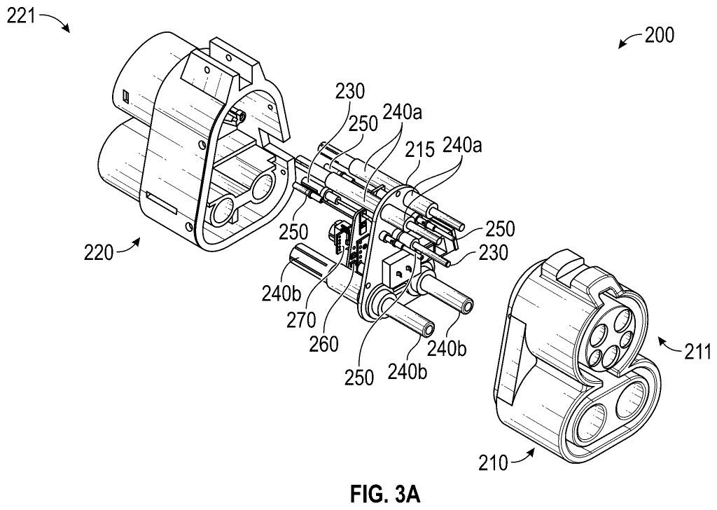

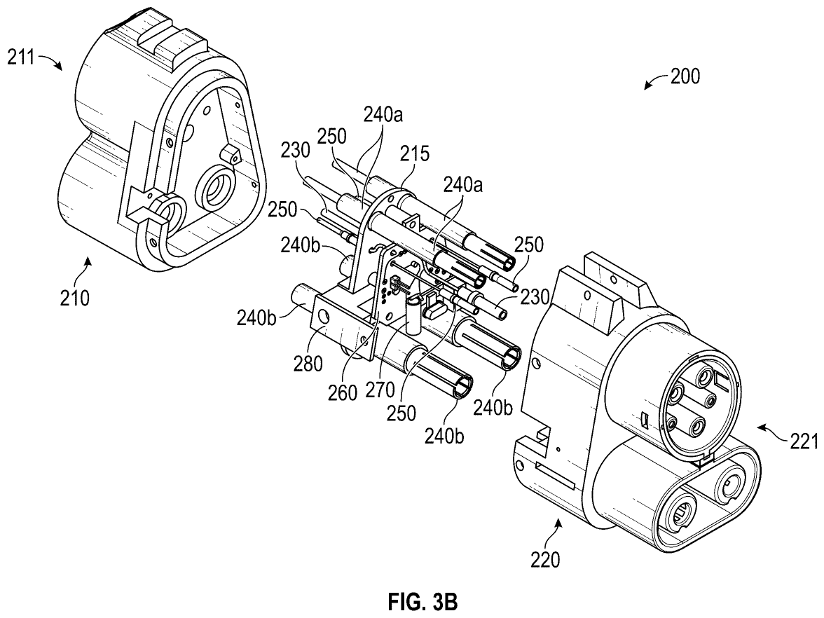

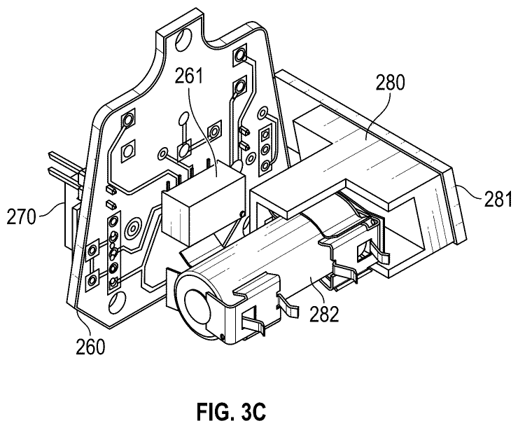

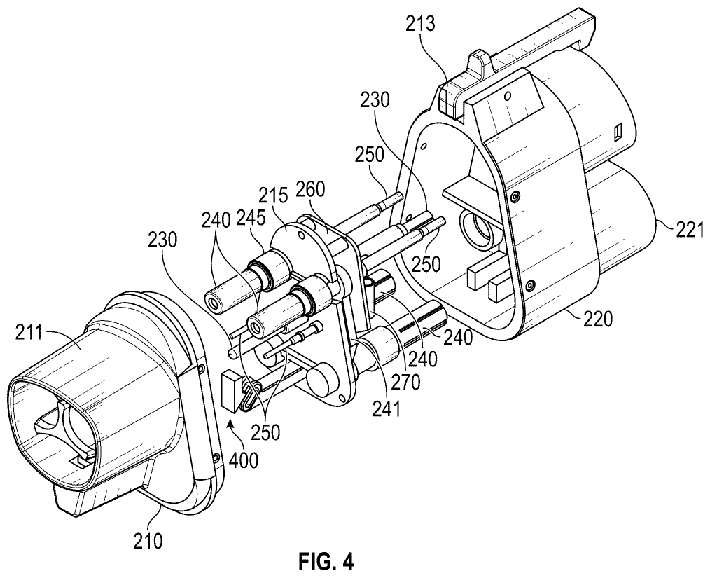

FIGS. 3A-3C are additional views of adapter 200 as shown in FIG. 2A. In FIGS. 3A and 3B, which are outer and inner perspective views respectively, the outer covers of adapter 200 are separated to show an example of how the internal components could be configured. FIG. 3C shows example circuitry that could be used within adapter 200. FIG. 4 is an additional view of adapter 200 as shown in FIG. 2B but with the outer covers of adapter 200 removed.

In some embodiments, the internal components of adapter 200 may include a ground pin assembly 230, power pin assemblies 240, communication pin assemblies 250, circuitry 260 having one or more switching elements 261, and a receiver 270. In some embodiments, an adapter 200 may include a support 215 for supporting some or all the internal components. In some embodiments, an adapter 200 may also include a battery assembly 280 for powering receiver 270. In other embodiments, receiver 270 could be powered from one or more of power pin assemblies 240 or possibly one or more of communication pin assemblies 250.

In some embodiments, ground pin assembly 230, each power pin assembly 240, and each communication pin assembly 250 can be configured to separate from inner portion 220 when outer portion 210 is pulled away from inner portion 220 (e.g., when the driver drives away while the charging connecter remains plugged in). The Incorporated References provide various examples of how these assemblies could be configured to enable this break-away functionality. In some embodiments, ground pin assembly 230, each power pin assembly 240, and/or each communication pin assembly 250 could include an inner portion and an outer portion that separate from one another. For example, in FIGS. 3A and 3B, each power pin assembly 240 includes inner and outer portions that are press fit together, while ground pin assembly 230 and each communication pin assembly 250 includes inner and outer portions that are interconnected via a wire.

In other embodiments, any or all of ground pin assembly 230, each power pin assembly 240 and each communication pin assembly 250 could be formed as a solid pin that physically separates from the inner or outer portion and remains in the other portion. For example, each such pin could be securely integrated into inner portion and removably coupled with outer portion so that outer portion can pull away from the pins to implement the break-away functionality.

When adapter 200 includes at least one CCS end, such as in FIGS. 2A and 2B, there may be two sets of power pin assemblies 240a and 240b corresponding to the low-power AC and high-power DC charging options respectively. However, an adapter 200 could be configured with only power pin assemblies 240a (e.g., when only low-power charging is supported) or power pin assemblies 240b (e.g., when only high-power charging is supported).

In the CCS-CCS version of adapter 200, such as is shown in FIGS. 3A and 3B, each power pin assembly 240a and each power pin assembly 240b may include an outer portion that is connected directly to a corresponding inner portion (e.g., via a press fit). Contrary to what is shown in FIGS. 3A and 3B, and as stated above, in some embodiments, power pin assemblies 240a or power pin assemblies 240b could be omitted.

In a CCS-NACS version, such as is shown in FIG. 4, each power pin assembly 240 could include a conductive connector 241 for interconnecting/adapting the inner portion and the outer portion. In FIG. 4, power pin assemblies 240 are configured for DC charging. Therefore, each connector 241 extends generally vertically from the outer portion of the corresponding power pin assembly 240 to the inner portion of the corresponding power pin assembly 240. In some embodiments, each end of connector 241 could form a press fit connection with the end of the inner and outer portions of the corresponding power pin assembly 240.

In some embodiments, the inner and outer portions of ground pin assembly 230 and/or each communication pin assembly 250 may be electrically connected via circuitry 260. Circuitry 260 could be in the form of a circuit board or any other suitable component that can electrically isolate an inner portion and an outer portion of one or both of communication pin assemblies 250. For example, circuitry 260 could connect the inner and outer portions via switching element 261. In such cases, when switching element 261 is closed, an electrical connection may be formed through communication pin assemblies 250.

Switching element 261 could be any component(s) capable of selectively forming an electrical connection between the charging port and the charging connector such as through their respective communication pins. In some embodiments, switching element 261 could have a default closed position such that the electrical connection is formed by default.

In other embodiments, switching element 261 could have a default open position such that the electrical connection is formed in response to some event such as manual driver actuation or actuation from a locking mechanism within the charging port and/or on the charging connector. In such cases and in some embodiments, switching element 261 could be one or more reed switches, one or more hall effect switches, one or more hall effect sensors, one or more magnetoresistive sensors, one or more electromagnetic relays, etc. that may be closed in response to a magnetic element being moved towards switching element 261 (e.g., in response to the EV actuating a locking tab/mechanism within the charging port).

The manner in which switching element 261 is configured to create/maintain the electrical connection is not essential to embodiments of the present disclosure. Of relevance is the ability of switching element 261 to terminate the electrical connection. In particular, receiver 270 can be configured to cause switching element 261 to terminate the electrical connection in response to receiving a transmitted signal. As such, the driver or other individual can terminate the electrical connection between the charging port and the charging connector to allow the EV to be shifted from park by simply transmitting the signal.

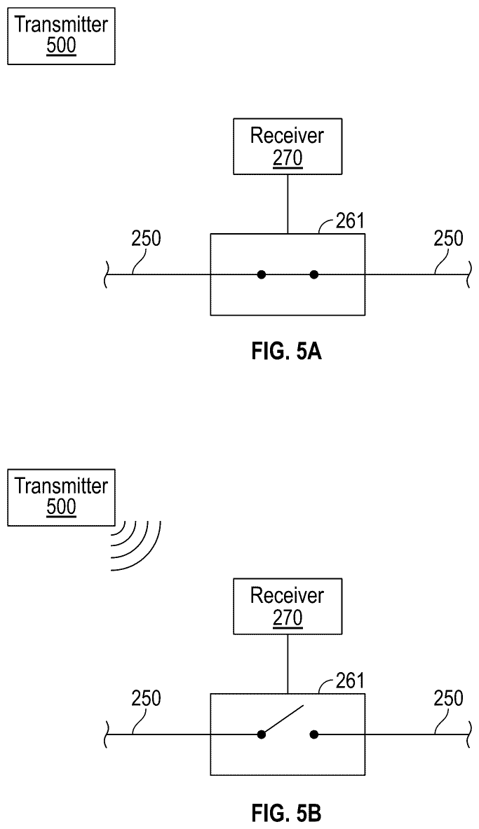

FIGS. 5A and 5B provide an example of how receiver 270 may be configured to interface with switching element 261 in one or more embodiments of the present disclosure. In FIG. 5A, switching element 261 is shown in the closed position and it is assumed that a transmitter 500 has not transmitted a signal to receiver 270. Then, in FIG. 5B, it is assumed that transmitter 500 has transmitted the signal to receiver 270. As shown, receiver 270 can be interfaced in some manner with switching element 261 so that receiver 270 can cause switching element 261 to terminate the electrical connection between the charging port and the charging connector in response to receiving the signal from transmitter 500.

Receiver 270 can be any one or more components that are capable of receiving and identifying a particular wireless signal transmitted by transmitter 500. For example, receiver 270 could include an antenna and a processing element. The processing element can be configured to process signals received via the antenna to detect when the particular wireless signal has been received. When the particular wireless signal is detected, the processing element can output one or more control signals to cause switching element 261 to terminate the electrical connection between the charging port and the charging connector (e.g., by ceasing to connect the inner and outer portions of at least one of communication pin assemblies 250). In some embodiments, the one or more control signals may directly cause switching element 261 to terminate the electrical connection (e.g., by opening a switch of switching element 261). In other embodiments, the one or more control signals may cause one or more intermediary components to interact with switching element 261 to terminate the electrical connection (e.g., by moving an intermediary component that was positioned to establish the electrical connection via switching element 261).

Receiver 270 could be configured to use any suitable protocol or mode of communication to receive the particular wireless signal. For example, receiver 270 could be configured to receive the particular wireless signal from a dedicated transmitter (e.g., transmitter 500 could be a dedicated fob). As another example, receiver 270 could be configured to use Bluetooth, Wi-Fi, Homelink or another protocol to receive the particular wireless signal from a mobile application on a driver's smartphone (e.g., transmitter 500 could be the smartphone running the mobile application). As another example, receiver 270 could be programmable to treat a garage door code as the particular wireless signal (e.g., transmitter 500 could be a dedicated garage door remote or an in-vehicle HomeLink transceiver where the often unused third button is dedicated to sending the particular wireless signal).

In some embodiments, such as is shown in FIG. 3C, adapter 200 may include a battery assembly 280 with a battery 282 for powering receiver 270. Battery assembly 280 may include a removable cover 281 so that battery 282 may be replaced as necessary.

In some embodiments, battery assembly 280 could be electrically connected to one or more of power pin assemblies 240 (or possibly communication pin assemblies 230) via circuitry 260 in a manner that allows battery 282 to be charged when adapter 200 is used during EV charging. In some embodiments, circuitry 260 could be configured to provide power to receiver 270 directly from power pin assemblies 240 (or possibly from communication pin assemblies 250) such that battery assembly 280 is unnecessary.

In some embodiments, adapter 200 can be configured to automatically reestablish the electrical connection between the charging port and the charging connector if the charging connector is not unplugged from the charging port. This may be beneficial to allow the charging station to detect the presence of the EV after the electrical connection has been terminated.

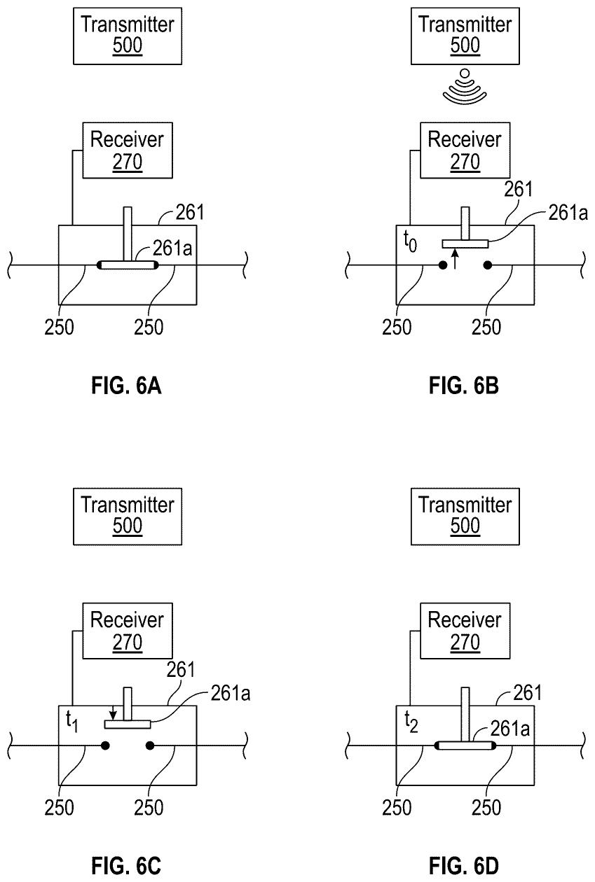

FIGS. 6A-6D provide an example, in the context of FIGS. 5A and 5B, of how adapter 200 could be configured to automatically reestablish the electrical connection after a delay in one or more embodiments. In this example, switching element 261 includes a plunger 261a (or moving element) that forms the electrical connection in its default position. For example, plunger 261a could be biased into the position shown in FIG. 6A in which it connects the inner and outer portions of a communication pin assembly 250 (e.g., via pads or other conductive elements formed in or connected to circuitry 260).

As shown in FIG. 6B, it is assumed that at a time, to, receiver 270 receives the signal from transmitter 500 and, in response, interfaces with switching element 261 to cause plunger 261a to be withdrawn or otherwise moved so that the electrical connection is no longer formed. For example, receiver 270 could cause a current to flow through a coil positioned around plunger 261a to thereby create a magnetic force that withdraws plunger 261a. As another example, receiver 270 could include or be connected to a mechanical actuator that physically moves plunger 261a.

At this point, the driver could shift the EV from park and drive away from the charging station, including without unplugging the charging connector and adapter 200 from the charging port if necessary. However, in some cases, the driver may not unplug the charging connector and adapter 200 or drive away.

In some embodiments, such as is represented in FIGS. 6C and 6D, plunger 261a can be configured to return to its default position after a delay to thereby reestablish the electrical connection if the charging connector remains plugged in via adapter 200. For example, in FIG. 6C, it is assumed that an amount of time, t1, less than the delay has elapsed and plunger 261a has returned towards its default position but has not yet reached it. Then, in FIG. 6C, it is assumed that an amount of time, t2, equal to or greater than the delay has elapsed and plunger 261a has reached its default position such that the electrical connection will be reestablished if the EV remains plugged in. Plunger 261a and/or switching element 261 can be configured in any suitable way to accomplish a desired delay (e.g., a delay of 30 seconds, 1 minute, 2 minutes, etc.). For example, plunger 261a may be contained within a cylinder that provides a coefficient of friction, a pressure differential, or some other mechanical force that slows the return of plunger 261a to its default position. Configuring plunger 261a to return to its default position through mechanical force can eliminate the need to retain power throughout the delay and can therefore ensure that switching element 261 can have a default closed configuration.

In some embodiments, adapter 200 could be configured to accomplish the delay using a timer or other electronic means. For example, receiver 270 or switching element 261 could implement a timer that is started when the electrical connection is terminated. When the timer has elapsed, the electrical connection can be reconnected. In such cases, adapter 200 could include battery assembly 280 so that the timer can be powered throughout the delay. As another example, adapter 200 could include a capacitor that begins to discharge when the signal is received. The capacitor can interface with plunger 261a (or other component of switching element 261) so that the electrical connection is reestablished once the capacitor has been discharged below a threshold voltage.

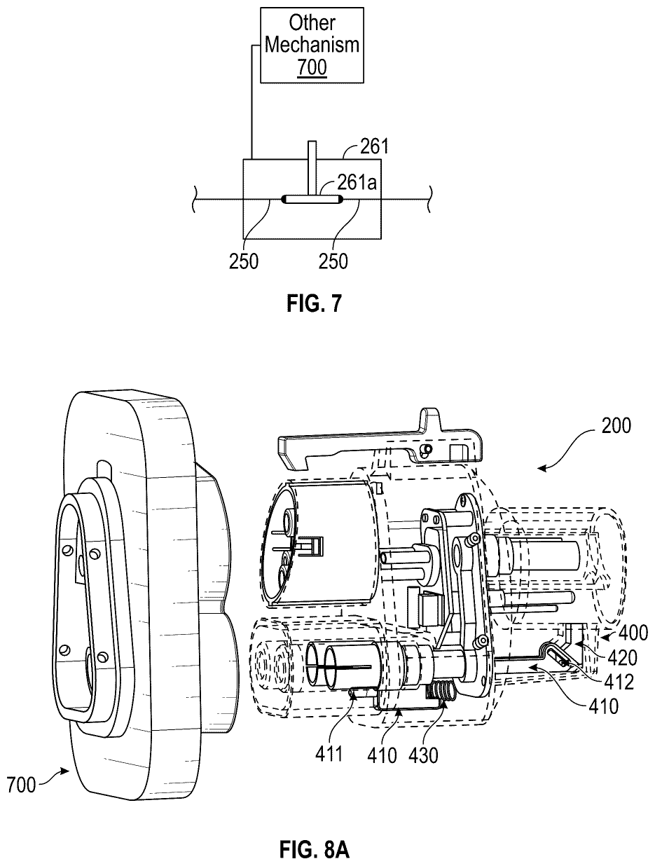

Any of these techniques for reestablishing the electrical connection after a delay could be employed on an adapter 200 that does not include receiver 270. For example, plunger 261a could be configured to be withdrawn from its default position using some other mechanism 700 as shown in FIG. 7. This other mechanism 700 could be activated, a timer could be started, a capacitor could begin discharging, etc., in response to the charging of the EV being terminated (e.g., in response to detecting that power pin assemblies 240 are no longer powered), in response to detecting that a locking mechanism has been withdrawn on the charging port and/or the charging connector, etc.

In short, any suitable technique can be employed on adapter 200 to ensure that the electrical connection is reestablished if the driver does not unplug the EV (whether manually or by driving away). By reestablishing the electrical connection, adapter 200 can allow the driver to resume charging without first unplugging and plugging back in the charging connector.

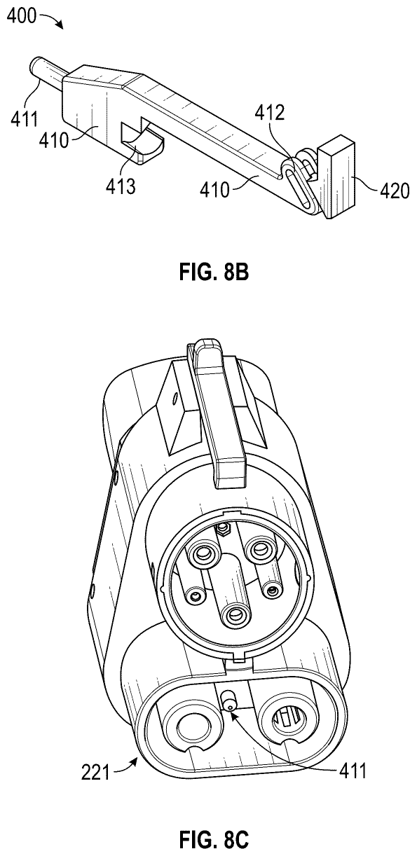

FIGS. 8A-8C as well as FIG. 4 provide an example of how an adapter 200 can include a locking mechanism 400. In this example, locking mechanism 400 is configured to lock a NACS (or Tesla) charging connector (not shown) in end 211 of adapter 200 when end 221 of adapter 200 is inserted into a CCS charging port 700. However, similar locking mechanisms could be employed in other types of adapters 200.

As best shown in FIG. 8B, which shows locking mechanism 400 in isolation, locking mechanism 400 may include a main body 410 having an elongated shape that extends between outer portion 210 and inner portion 220 of adapter 200. An extension 411 may be formed at an inner end of main body 410 and may be biased to extend beyond a wall of end 221. As a result, when adapter 200 is inserted into charging port 700, extension 411 will be forced outwardly (i.e., extension 411 will be pushed into adapter 200). Locking mechanism 400 can include a spring (or other biasing member) 430 that biases main body 410 and extension 411 into this position.

Locking mechanism 400 can also include a tab member 420 that is configured to move vertically relative to main body 410 (assuming main body 410 is in a horizontal orientation) when main body 410 is moved horizontally within adapter 200. In particular, when extension 411 extends through the wall of end 221, tab member 420 will be lowered due to the orientation of slot 412 by which tab member 420 is coupled to main body 410. Then, when extension 411 is forced into adapter 200 when adapter 200 is plugged into charging port 700, tab member 420, which is restrained from moving horizontally within adapter 200, will be forced upwardly by the horizontal movement of main body 410. Tab member 420 can be positioned within a channel in outer portion 210 that aligns with the locking slot in the NACS charging connector so that tab member 420 will lock the NACS charging connector within end 211 while end 221 remains inserted into charging port 700.

A similar mechanism could be used on a CCS-CCS adapter 200 (e.g., adapter 200 shown in FIG. 2A). However, EVs that are configured for CCS (or J1772) employ a large variety of locking mechanisms. Therefore, adapter 200 can be customized to include a suitable locking mechanism 400 for a particular EV.

As one example, adapter 200 in FIG. 4 includes a common locking arm 213 that is employed on CCS charging connectors. Some EVs have charging ports that include a locking tab that extends overtop the inner end of locking arm 213 to prevent an individual from pressing on the outer end of locking arm 213 to pivot inner end upwardly to free the charging connector. In some embodiments, a locking mechanism 400 could be configured to leverage this type of locking arm 213. For example, main body 410 of locking mechanism 400 could have an inner side that is structured similar to locking arm 213 but also includes an upward protrusion that is inline with the charging port's locking tab so that the locking tab contacts the protrusion when it is extended. This contact can in turn move main body 410 of locking mechanism 400 horizontally in a similar manner as would occur in the embodiment shown in FIGS. 8A-8C. The outer end of main body 410 could be configured to form a locking tab that is moved overtop a locking arm 213 that may be included on the CCS charging connector. In other words, in comparison to locking arm 213 in FIG. 4, main body 410 could extend outwardly sufficiently to be positioned overtop the charging connector when it is inserted into end 211 (which notably would be configured as shown in FIG. 2A, not as in FIG. 4). In such embodiments, main body 410 can be pivotable so that the inner end can be lifted upwardly to free end 221 of adapter 200 from the charging port once the charging port's locking tab is withdrawn.

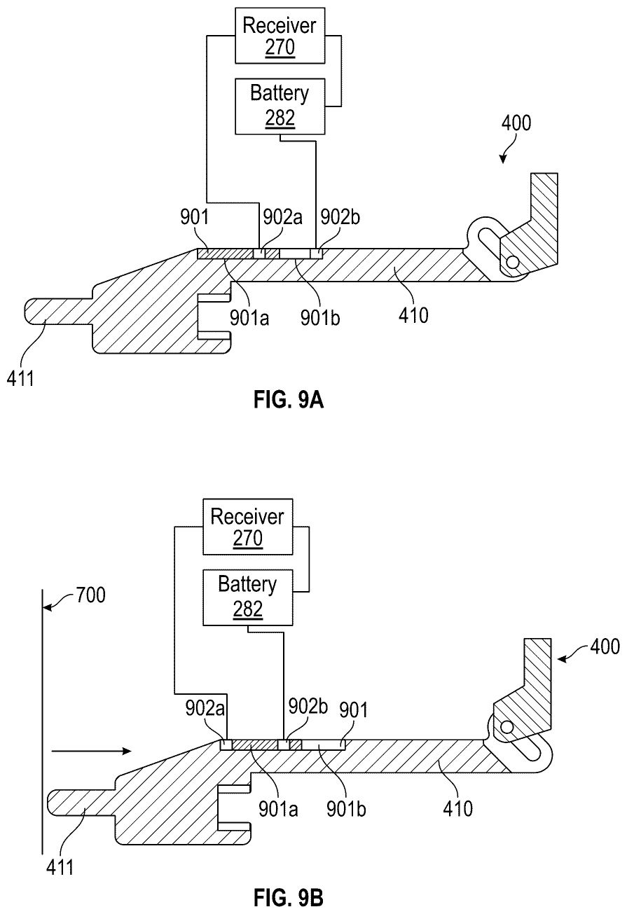

In some embodiments, adapter 200 can be configured so that receiver 270 (and/or any other component) is only powered when adapter 200 is plugged into the charging port and/or when the charging connector is plugged into adapter 200. FIGS. 9A and 9B provide one example of how this may be accomplished.

In FIGS. 9A and 9B, locking mechanism 400 is configured to selectively connect battery 282 to receiver 270. For example, main body 410 of locking mechanism 400 could form a channel 901 in which contacts 902a and 902b are positioned. Contacts 902a and 902b may be connected to terminals of receiver 270 and battery 282 respectively such that battery 282 will only power receiver 270 when contacts 902a and 902b are electrically connected.

Channel 901 can include a conductive portion 901a and a non-conductive portion 901b. When adapter 200 is not plugged into charging port 700, main body 410 will be in its default position. With main body 410 in this default position, contact 902b will be positioned in non-conductive portion 901b such that battery 282 will be disconnected from receiver 270. In contrast, when adapter 200 is plugged in to force extension 411 into adapter 200, both contacts 902a and 902b will be positioned within conductive portion 901a thereby connecting battery 282 to receiver 270. Accordingly, while adapter 200 remains plugged into charging port 700, receiver 270 will be able to receive the signal from transmitter 500 to determine when the electrical connection between the charging port and the charging connector should be terminated. Because battery 282 is only connected when adapter 200 is plugged in, the battery life can be greatly extended.

In some embodiments, adapter 200 may also include a transmitter. For example, receiver 270 could be a transceiver, or a transmitter separate from receiver 270 could be included. This transmitter could be employed to transmit charging data (which may be collected by circuitry, sensors, etc. on adapter 200) to an external device/system. For example, the transmitter could transmit charging data to a mobile application on a user's smart phone, to a subsystem of the EV, or any other device or system that may store and/or process the charging data directly and/or relay the charging data to a server. For example, a cloud service could be provided for aggregating charging data to facilitate analysis of the performance of adapter 200 (e.g., charging temperatures, current measurements, etc.), to enable the user to review statistics (e.g., charge time, charge location, etc.), or to provide any other suitable information, whether to the user, to the manufacturer of adapter 200, to the manufacturer of the EV or charging station, to a governmental or regulatory authority, or to another entity or individual.

What is claimed:

1. An adapter for an electric vehicle comprising:
an inner portion configured to insert into a charging port of an electric vehicle;
an outer portion configured to receive a charging connector for charging the electric vehicle;
circuitry that is configured to establish an electrical connection through one or more communication pin assemblies; and
a receiver that is configured to terminate the electrical connection in response to receiving a wireless signal.

2. The adapter of claim 1, wherein the circuitry includes a switching element.

3. The adapter of claim 1, wherein the inner portion and the outer portion are configured in accordance with the combined charging system (CCS) standard.

4. The adapter of claim 1, wherein one of the inner portion and the outer portion is configured in accordance with the combined charging system (CCS) standard and the other of the inner portion and the outer portion is configured in accordance with the North American Charging Standard (NACS).

5. The adapter of claim 1, wherein the inner portion and the outer portion are configured in accordance with the NACS.

6. The adapter of claim 1, further comprising:
one or more power pin assemblies; and
a ground pin assembly;
wherein at least one of the ground pin assembly, the one or more power pin assemblies, or the one or more communication pin assemblies includes a pin that is securely integrated into the inner portion and removably coupled with the outer portion such that the outer portion pulls away from the pin when the outer portion breaks away from the inner portion.

7. The adapter of claim 1, wherein the circuitry is configured to reestablish the electrical connection after a delay.

8. The adapter of claim 7, wherein the circuitry is configured to reestablish the electrical connection after the delay in response to movement of one or more mechanical members.

9. The adapter of claim 8, wherein the one or more mechanical members include a plunger.

10. The adapter of claim 1, further comprising:
a battery for powering the receiver.

11. The adapter of claim 10, wherein the battery is selectively connected to the receiver when the adapter is inserted into a charging port.

12. The adapter of claim 11, further comprising:
a locking mechanism that selectively connects the receiver to the battery when the adapter is inserted into a charging port.

13. The adapter of claim 1, further comprising:
a transmitter that transmits charging data to an external device or system.

14. An adapter for an electric vehicle comprising:
an inner portion configured to insert into a charging port of an electric vehicle;
an outer portion configured to receive a charging connector for charging the electric vehicle; and
circuitry that is configured to establish an electrical connection through one or more communication pin assemblies;
wherein the circuitry is further configured to terminate the electrical connection and then to automatically reestablish the electrical connection after a delay.

15. The adapter of claim 14, wherein the circuitry automatically reestablishes the electrical connection after the delay when the adapter remains inserted into the charging port of the electric vehicle.

16. The adapter of claim 14, further comprising:
one or more members that move to cause the circuitry to automatically reestablish the electrical connection after the delay.

17. The adapter of claim 16, wherein the one or more members also move to cause the circuitry to terminate the electrical connection.

18. An adapter for an electric vehicle comprising:
an inner portion configured to insert into a charging port of an electric vehicle;
an outer portion configured to receive a charging connector for charging the electric vehicle; and
a locking mechanism that is configured to lock the charging connector in the outer portion while the inner portion is inserted into the charging port.

19. The adapter of claim 18, wherein the locking mechanism includes a main body that moves horizontally when the inner portion is inserted into the charging port and a tab member that moves vertically when the main body moves horizontally.

20. The adapter of claim 18, further comprising:
a receiver; and
a battery;
wherein the locking mechanism is configured to selectively connect the battery to the receiver while the inner portion is inserted into the charging port;
wherein the locking mechanism includes an inner portion that is moved by a locking mechanism of the charging port and an outer portion that interfaces with the charging connector in response to the movement of the inner portion.
